(19) United States
(12) Patent Application Publication
(10) Pub. No.: US 2004/0125141 A1
(43) Pub. Date: Jul. 1, 2004

(54) Image forming apparatus and method for controlling the same

(75) Inventor: Shinya Mori, Numazu-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/330,186

(22) Filed: Dec. 30, 2002

(51) Int. Cl. G09G 5/00

(52) U.S. Cl. 345/765

(57) ABSTRACT

This image forming apparatus comprises a touch panel which displays touch keys, accepts key operations by a user, and displays predetermined messages including operation states and operation guides for a user, a control unit which controls to change predetermined settings including the layout, size and function of a desired touch key in the touch panel provided as a user interface, based on the touch panel operations by a user, and a memory unit which stores the changed information on the user interface.

### BACKGROUND OF THE INVENTION

The present invention relates to an image forming apparatus and method for controlling the same. More specifically, the invention relates to an image forming apparatus which has a customizable user interface, a function of saving and transferring the information on a customized user interface, and improved operability and convenience, and a method for controlling the same.

In a conventional image forming apparatus, several function setting screens, e.g., a copy setting screen or a fax setting screen, are previously displayable as a user interface. For example, when the copy function is frequently used, the user interface is previously set so that the copy setting screen is automatically displayed as a default screen.

However, in the conventional example, the setting conditions and screen contents are the same for every user. In other words, when setting a certain function, the operation or the number of key touches is the same regardless of the frequency of using that function. Therefore, the operability is lower for a user who frequently uses the function requiring a relatively large number of operations. In addition, as the function level rises, the number of icons in the setting screen increases, placing greater demands on the user.

### BRIEF SUMMARY OF THE INVENTION

It is an object of the present invention to provide an image forming apparatus which has a customizable user interface and a function of saving and transferring the information on the customized user interface, wherein all users can set, save and use a suitable setting screen for improving operability and convenience, and a method for controlling the same.

In order to achieve the above object of the invention, according to a first aspect of the present invention, there is provided an image forming apparatus with a control panel comprising a touch panel which displays touch keys, accepts key operations by a user, and displays predetermined messages including operation states and operation guides for a user; a control unit which controls to change predetermined settings including the layout, size and function of a desired touch key in the touch panel provided as a user interface, based on the touch panel operations; and a memory unit which stores the changed information on the user interface.

According to a second aspect of the present invention, there is provided an image forming apparatus with a control panel, comprising a touch panel which displays touch keys, accepts key operations by a user, and displays predetermined messages including operation states and operation guides for a user; a control unit which controls to change predetermined settings including the layout, size and functions of a desired touch key in the touch panel provided as a user interface, based on the tough panel operations; a memory unit which stores the changed information on the user interface; and a communication unit which sends the information stored in the memory to an external device and receives the changed information on the user interface sent from an external device; wherein the control unit changes the predetermined settings including the layout, sizes, and functions of the touch keys, based on the changed information on the user interface, when receiving the information from an external device through the communication unit.

According to a third aspect of the present invention, there is provided a method of controlling an image forming apparatus with a control panel, comprising displaying touch keys, accepting key operations by a user, and displaying predetermined messages including operation states and operation guides for a user on a touch panel; controlling with a control unit to change predetermined settings including the layout, size and function of a desired touch key in the touch panel provided as a user interface, based on the touch panel operations; and storing in a memory unit the changed information on the user interface.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing a configuration of an image forming apparatus to which embodiments of the present invention are applicable;

FIG. 2 is a flow chart showing an example of customization of the user I/F in an image forming apparatus to which embodiments of the present invention are applicable;

FIG. 3A is a view showing a setting screen 21 related to basic printing before customization;

FIG. 3B is a vies showing a setting screen 22 related to application printing before customization;

FIG. 3C is a view showing a setting screen 23 related to basic printing after customization;

FIG. 3D a vies showing a setting screen 24 related to application printing after customization;

FIG. 4 is a flow chart explaining a series of processes related to reading the information on user I/F in an image forming apparatus to which embodiments of the present invention are applicable; and

FIG. 5 is a block diagram showing a configuration of an image forming apparatus with a radio communication unit 20, as an improved embodiment of the present invention.

### DETAILED DESCRIPTION OF THE INVENTION

Hereinafter, preferred embodiments of the present invention will be explained with reference to the accompanying drawings.

In an image forming apparatus according to the embodiments of the present invention, a default display screen of a user interface (referred to a user I/F hereinafter), menu hierarchy and key assignment can be settable for each user. Further, these settings are callable by entry of a code number or depression of a registry key on a touch panel. A user I/F is made customizable for each user and application and callable at need, improving operability and convenience. Embodiments of the present invention will be described in detail hereinafter.

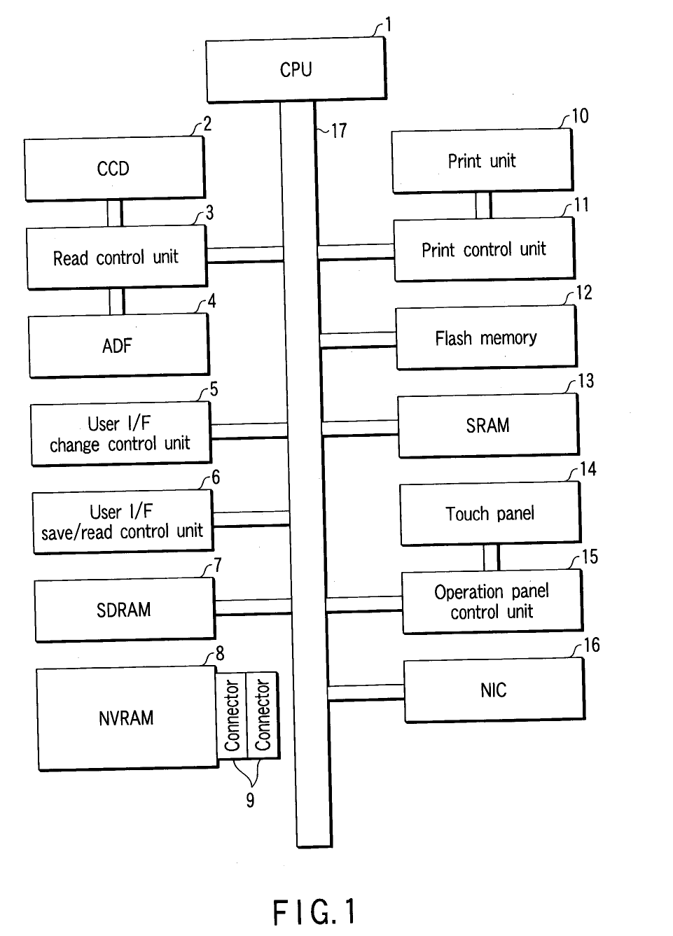

FIG. 1 is a block diagram showing a configuration of an image forming apparatus to which embodiments of the present invention are applicable. The apparatus can be a digital composite machine which has various functions including copy, print, scanner and fax.

As shown in FIG. 1, a CPU 1 (Central Processing Unit) as a control unit, a read control unit 3, a user I/F change control unit 5, a user I/F store and read control unit 6, an SDRAM (Synchronous DRAM) 7, a print control unit 11, a flash memory 12, an SRAM (Static RAM) 13, an operation panel control unit 15, and a NIC (Network Interface Card) 16 are connected through a control bus 17, so that they can communicate to one another. Further, a NVRAM 8 is removably connected to the control bus 17 through connectors 9. The read control unit 3 is connected to a CCD (Charge Coupled Device) 2 and ADF (Auto Document Feeder) 4. The print control unit 11 is connected to a print unit 10, and the operation panel control unit 15 is connected to a touch panel 14 comprising a liquid crystal display (LCD) or the like.

In the above configuration, the CPU 1 controls the whole system. The read control unit 3 controls the CCD 2 to read a document image. At this time, when double side printing is desired, the read control unit 3 also drives and controls an ADF 4.

The user I/F change control unit 5 controls to change the user I/F, based on the touch panel operations by a user, as explained in detail later. The user I/F store and read control unit 6 controls to read the previously stored information about the user I/F from the SDRAM 7 and NVRAM 8, or store the user I/F customized by operating the touch panel 14, that is, the information on the user setting screen, in the SDRAM 7 or NVRAM 8 as a memory.

The print control unit 11 is a device to print a document image on a print medium by controlling the print unit 10. The flash memory 12 functions as a memory to store programs and data. The SRAM 13 functions as a memory for operations and data storage. The operation panel control unit 15 controls operations of the touch panel 14. The touch panel 14 also displays the operation states of the image forming apparatus and operation guide messages for a user. Further, the network interface card (NIC) formed like a card enables entry of data from an external unit such as a personal computer.

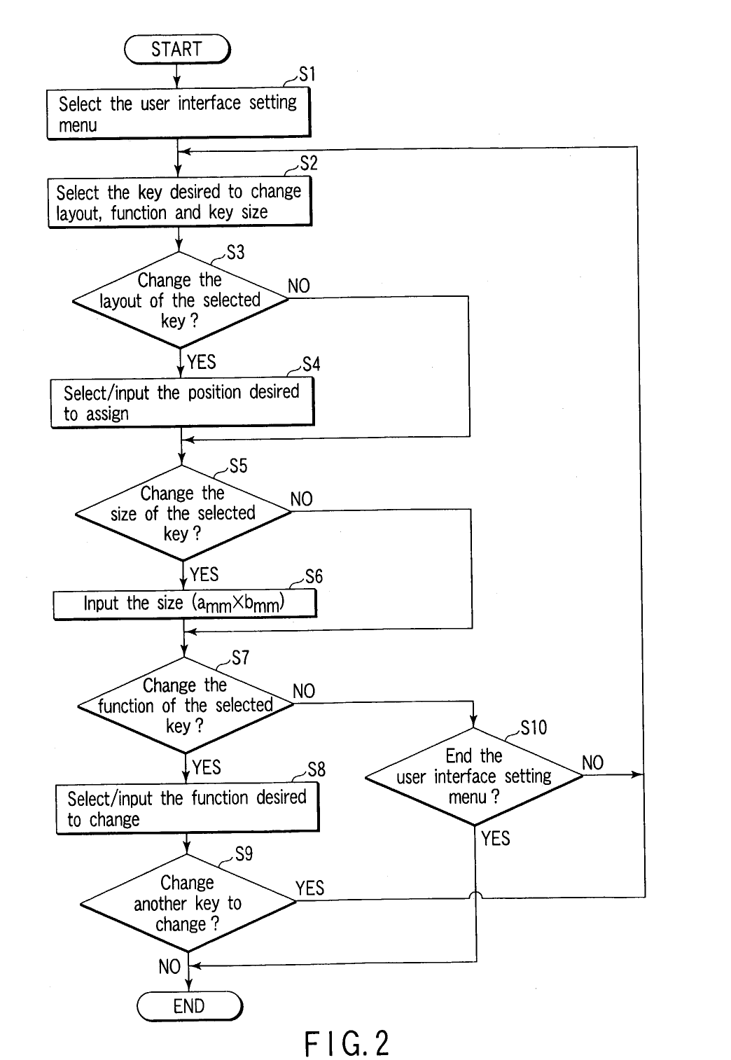

Description will now be given of an example of customizing the user I/F by the image forming apparatus, to which embodiments of the invention are applicable, with reference to the flow chart of FIG. 2. This corresponds to an example of a method of controlling an image forming apparatus to which embodiments of the invention are applicable.

First, operate the touch panel 14 to select a user I/F customizing menu (step S1), and operate the touch panel 14 or enter a key name to select a key desired to change its layout, function and key size (step S2). At this time, select also the item of the selected key desired to change (e.g., layout, function and key size).

The CPU 1 determines whether the layout change is selected for the above selected item (step S3), and when the layout change is selected, determines the change destination (step S4) by accepting the choice on the touch panel 14 desired to newly lay out, or by accepting entry of coordinate positions. When the layout change is not selected in the above step S3, go to step S5.

Then, the CPU 1 determines whether the key size change is selected for the above selected item (step S5), and when the key size change is selected, determines the changed key size (step S6) based on the corresponding data by accepting the size data entered from the ten-key pad (not shown), or by accepting the size data selected from the previously registered data. When the key size change is not selected in the above step S5, go to step S7.

Then, the CPU 1 determines whether the key function change is selected for the above selected item (step S7), and when the key function change is selected, the CPU 1 accepts entry of the function name and function desired to change, and makes setting for the new function for the corresponding key (step S8).

Further, the CPU 1 determines whether there is another key desired to change its setting (step S9). The CPU 1 determines here based on the operations of the touch panel 14 by a user and the selection in the above step S11. When there is another key desired to change its setting in this step S9, the CPU 1 returns to and repeats the step S2. When there is no key desired to change its setting, the CPU 1 terminates the series of operations.

On the other hand, when the key function change is not selected in the step S7, the CPU 1 determines whether to terminate the user I/F setting menu (step S 10), and goes back and repeats the step S2 when the setting menu is continued, and terminates the series of operations when the setting menu is terminated.

By the above-mentioned series of operations, the layout, function and key size are changed and the information newly set on the user I/F is related to the user identification information and stored in the SDRAM 7 or NVRAM 8.

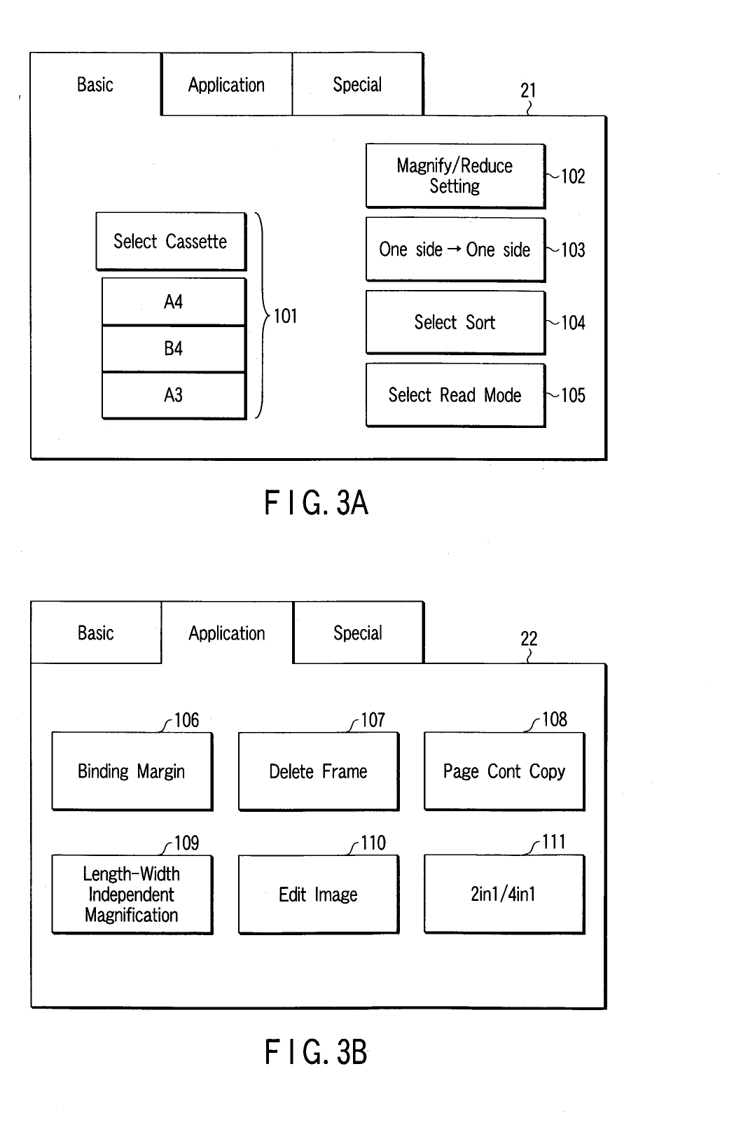

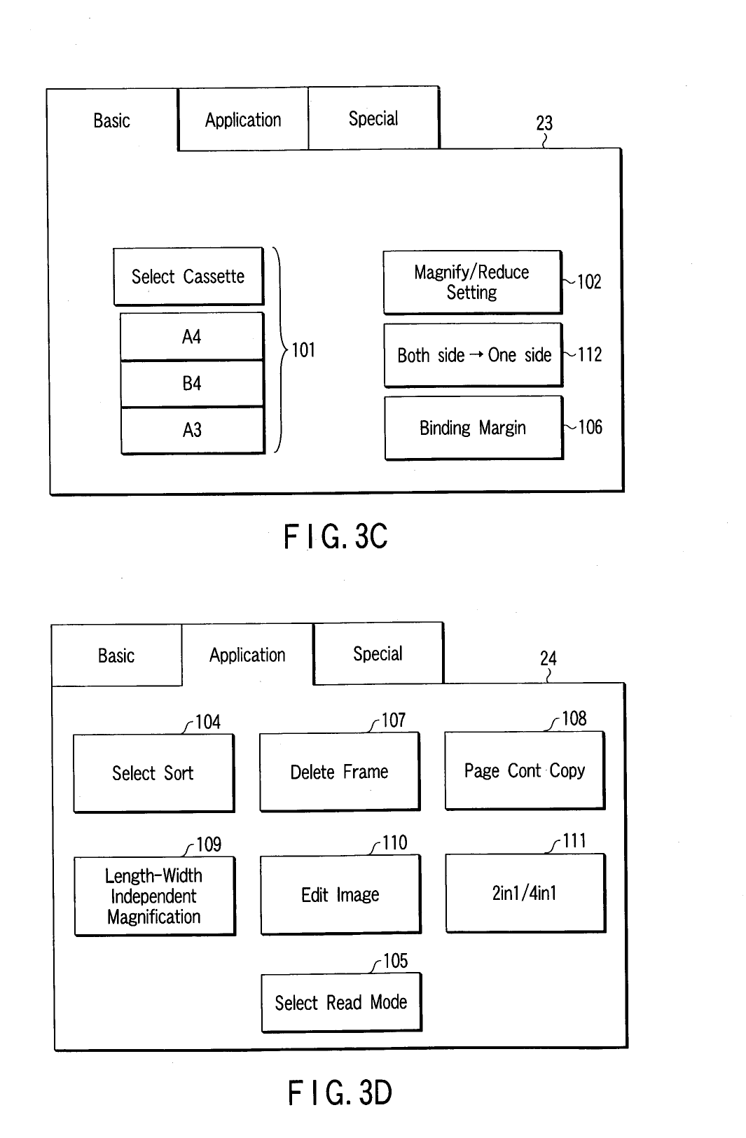

Description will now be given of an example of customizing the user I/F by the processes mentioned in FIG. 2 by referring to FIGS. 3A to 3D.

FIG. 3A shows the user I/F before customization, and in particular the setting screen 21 for basic printing. FIG. 3B also shows the user I/F before customization, and in particular the setting screen 22 for application printing.

As shown in FIG. 3A, before customization by the series of operations previously described in FIG. 2, in the setting screen 21 for basic printing, a cassette select key 101, a magnify/reduce setting key 102, a one side→one side (printing the image of one side of a manuscript to one side of a print medium) key 103, a sort select key 104, and a read mode select key 105 are selectively laid out.

As shown in FIG. 3B, before customization by the series of operations, in the setting screen 22 for application printing, a binding margin key 106, a delete frame key 107, a page continuous copy key 108, a length-width independent magnification change key 109, an edit image key 110, a 2in1/4in1 key 111 are selectively laid out.

On the other hand, FIG. 3C shows the user I/F after customization, and in particular the setting screen 23 for basic printing. Likewise, FIG. 3D shows the user I/F after customization, and in particular the setting screen 24 for application printing. As shown in FIGS. 3C and 3D, after customization by the previously mentioned series of operations, the read mode select key 105 in the screen 21 for basic printing is transferred to the screen 24 for application printing, and the key size is enlarged.

Further, the function of the one side→one side key 103 in the screen 21 for basic printing is changed to a both side→one side key 112, as shown in screen 23. It is also seen that the binding margin key 106 laid out in the screen 22 for application printing is transferred to the screen 23 for basic printing.

As described above, according to the series of operations in FIG. 2, it is possible to customize the layout, function and size of each key in the setting screen as the user desires, and it is seen that the changeable items are not limited to the layout, function and size of each key.

Further, in addition to an example of changing the key in the predetermined basic, application and special setting screens in FIGS. 3A to 3D, it is also possible to customize to provide a user's special setting screen and place frequently used keys in that screen.

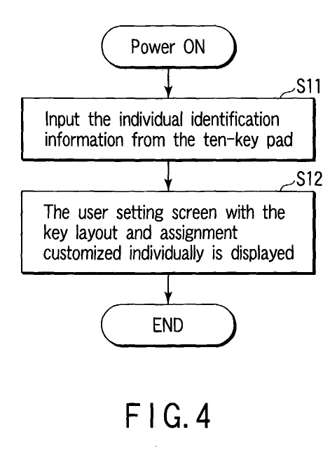

Next, description will be given on the readout of information on the user I/F by the image forming apparatus to which embodiments of the invention are applicable, or a series of operations concerning display of the user setting screen, by referring to the flow chart of FIG. 4. This corresponds to an example of a control method of the image forming apparatus to which embodiments of the invention are applicable.

After the power of the image forming apparatus is turned on, the user, who has already registered the user I/F information or whose user setting screen has been customized or registered, enters his (or her) identification information from a ten-key pad or one-touch key (not shown) (step S11). The CPU 1 reads out the user I/F information from the SDRAM 7 or NVRAM 8 by using the entered user identification information as a key, and displays the user setting screen on the touch panel 14 based on that information (step S12). The CPU finishes the series of operations. Thereafter, the user can easily instruct any desired operation from the user setting screen suitable for his (or her) own application.

The above description is an example of an operation realized by one image forming apparatus. When two or more image forming apparatuses are connected through a network so that they can communicate to one another, it is also possible that another image forming apparatus receives the user I/F information stored in the SDRAM or the like of one image forming apparatus through the network and displays the user setting screen based on that information.

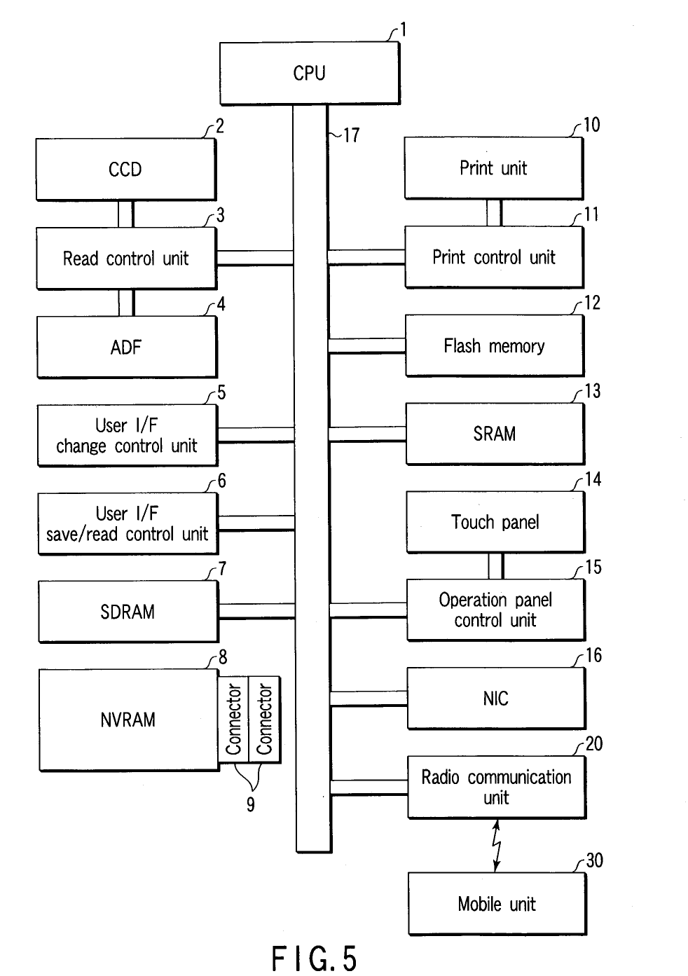

Further, as shown in FIG. 5, in the image forming apparatus with the radio communication unit 20, the same effect can be obtained by making radio communication with a mobile unit 30 such as a cellular phone. Namely, in this case, the layout, function and key size are changed by the series of operations shown in FIG. 2, and the information newly set on the user I/F is transmitted to the mobile unit 30 through the radio communication unit 20. The mobile terminal 30 stores the information in the memory.

When a composite unit of the same type or the type applicable to the image forming apparatus is used, the user setting screen can be displayed based on the received information by the same series of operations as those shown in FIG. 5, by making radio communication between the mobile unit 30 and the image forming apparatus used, and by sending the information on the user setting screen to the composite unit.

The above-mentioned radio communication unit 20 can adopt Bluetooth, which is a radio communication technology for mobile units, or IrDA (Infrared Data Association) which handles near-distance data communication utilizing infrared rays. The connection mentioned here is for radio communication, but it is possible to adopt a wired connection method which makes connection directly by using a cable.

As explained above, in the image forming apparatus to which embodiments of the present invention are applicable and in a method of controlling the apparatus, it is possible to customize the user setting screen to make it convenient for the user by simple operations on the touch panel 14 or the like. Further, it is possible to store the customized user I/F information in a memory such as SDRAM 7, read the information as needed, and display the user setting screen as needed. Therefore, in this image forming apparatus, the user's convenience and operability are improved.

Moreover, as in the above stage, the customized user I/F information is stored in the removable NVRAM 8 or user's cellular phone, and is readable from the NVRAM 8 by connecting the connector 9 or by making radio communication with the cellular phone, thereby the user can easily and quickly display and use the customized user setting screen in a composite unit which is usually unused or at a place near where the user is stationed. The apparatus of the invention is very convenient in this respect.

The invention is not limited by the above described embodiments, and may be modified and improved in various ways without departing from the its gist.

For example, although the key layout size and function are changed and the user setting screen is customized in the above described embodiments, it is also possible, when one user stores two or more user setting screens in a memory, to assign the priority to these screens according to the frequency of using the screens, and to use it as a guide when the user selects the screens. In this time, it is possible to display the selected screen in the ascending priority order.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus with a control panel, comprising:
a touch panel which displays touch keys, accepts key operations by a user, and displays predetermined messages including operation states and operation guides for a user;
a control unit which controls to change predetermined settings including the layout, size and function of a desired touch key in the touch panel provided as a user interface, based on the touch panel operations by a user; and
a memory unit which stores the changed information on the user interface.

2. The image forming apparatus according to claim 1, wherein the control unit changes the hierarchy of the predetermined setting menu related to copy, fax and network functions and the quantity of information displayed on the touch panel, based on the touch panel operations by a user.

3. The image forming apparatus according to claim 1, wherein the memory unit comprises a removable NVRAM.

4. The image forming apparatus according to claim 1, further comprising:
a communication unit which communicates with an external unit; wherein
the image forming apparatus sends information about the changed user interface stored in the memory unit through the communication unit, or receives information about the changed user interface from an external unit through the communication unit.

5. An image forming apparatus with a control panel, comprising:
a touch panel which displays touch keys, accepts key operations by a user and displays predetermined messages including operation states and operation guides for a user;
a control unit which controls to change predetermined settings including the layout, size and function of a desired touch key in the touch panel provided as a user interface, based on the touch panel operations by a user;
a memory unit which stores the changed information on the user interface; and
a communication unit which sends the information stored in the memory to an external device and receives the changed information on the user interface sent from an external device; wherein
the control unit changes the predetermined settings including the layout, sizes, and functions of the touch keys, based on the changed information on the user interface, when receiving the information from an external device through the communication unit.

6. The image forming apparatus according to claim 5, wherein the control unit changes the hierarchy of the predetermined setting menu related to copy, fax and network functions and the quantity of information displayed on the touch panel, based on the information sent from the external unit.

7. A method of controlling an image forming apparatus with a control panel, comprising:
displaying touch keys, accepting operations by a user, and displaying predetermined messages including operation states and operation guides for a user on a touch panel;
controlling with a control unit to change predetermined settings including the layout, size and function of a desired touch key in the touch panel provided as a user interface, based on the touch panel operations by a user; and
storing the changed information on the user interface in a memory unit.

8. The method of controlling an image forming apparatus according to claim 7, further comprising:
changing the hierarchy of the predetermined setting menu related to copy, fax and network functions and the quantity of information displayed on the touch panel, with the control unit, based on the touch panel operations by a user.

9. The method of controlling an image forming apparatus according to claim 7, further comprising:
sending information about the changed user interface stored in the memory unit through the communication unit, or receiving information about the changed user interface from an external unit through the communication unit.

10. The method of controlling an image forming apparatus according to claim 9, further comprising:
changing the predetermined settings including the layout, sizes, and functions of the touch keys, with the control unit, based on information about the changed user interface, when receiving the information from an external device through the communication unit.
